(19) United States
(12) Patent Application Publication
(10) Pub. No.: US 2004/0170012 A1
(43) Pub. Date: Sep. 2, 2004

(54) Light guide assembly with masking film, backlight system, front light system and liquid crystal display assembly incorporating same

(76) Inventors: Chuan-De Huang, Tu-Chen (TW); Charles Leu, Fremont, CA (US)

Correspondence Address: WEI TE CHUNG, FOXCONN INTERNATIONAL, INC., 1650 MEMOREX DRIVE, SANTA CLARA, CA, 95050, US

(21) Appl. No.: 10/788,689

(22) Filed: Feb. 26, 2004

(30) Foreign Application Priority Data
Feb. 26, 2003 (TW) 92202952

(51) Int. Cl. F21V 9/00

(52) U.S. Cl. 362/31; 362/293

(57) ABSTRACT

A light guide plate (412, 512) with masking film (413, 513) can be incorporated in a backlight system (41), a front light system (51) and a liquid crystal display assembly. In one embodiment, the light guide plate includes a light incidence surface (412a) for receiving light, a light emitting surface (412d) that orthogonally joins the light incidence surface, and the masking film. The masking film is provided on the light emitting surface for blocking UV rays from penetrating therethrough.

### BACKGROUND OF THE INVENTION

1. Field of the Invention

The invention generally relates to a light guide assembly, and particularly to a light guide assembly for use with a liquid crystal display (LCD), and which is resistant to discoloration due to external ultraviolet (UV) rays.

2. Related Art

A typical modern LCD is capable of displaying a clear and sharp image over a wide area. However, each liquid crystal cell in an LCD does not itself emit light. Instead, liquid crystal cell has to be lit up by an illumination system. The illumination system is located in back of a transmission type LCD, or located in front of a reflection type LCD that utilizes external light such as sunlight.

The illumination system generally includes a light guide plate (LGP) having at least one light incidence surface and one light emitting surface. The LGP guides the light between the light incidence and light emitting surfaces. The light is normally emitted by a lamp located adjacent to the light incidence surface, or is ambient light provided by the environment. In general, the LGP is made from polymethyl methacrylate (PMMA) or another suitable material such as cycloolefin polymer (COP), which can reduce the weight of the LGP. However, both PMMA and COP are susceptible to discoloration caused by the UV rays in the light emitted by the lamp.

U.S. patent application Ser. No. 2002/0141173 published on Mar. 1, 2002 discloses a backlight assembly using an LGP. The LGP is resistant to yellow discoloration even after long periods of use. The patent application specification describes a variety of solutions. A first solution provides a first masking film 703 coated on an inner surface of a glass tube 701 of a lamp 710 to cut down UV emissions from the lamp 710, together with a masking film 712a coated on an inner surface of the lamp cover 712 (see FIGS. 6-9 thereof). A second solution places the first masking film 703 on an outer surface of the glass tube 701 of the lamp 710 and includes the masking film 712a coated on the inner surface of the lamp cover 712 (see FIGS. 10-13 thereof). A third solution combines the first and second solutions described above. That is, the first masking film 703, a third masking film 703a and the second masking film 712a are respectively coated on the inner surface and outer surface of the glass tube 701 of the lamp 710 and the inner surface of the lamp cover 712, in order to cut down UV rays emitted by the lamp 710 (see FIGS. 14-17 thereof). A fourth solution places the first masking film 703 on a light incidence surface 721 of the LGP 720 to cut down UV rays emitted by the lamp 710, together with the second masking film 712a coated on the inner surface of the lamp cover 712 (see FIGS. 18-20 thereof). A fifth solution mixes an isolating material 703b into the LGP 720 for absorbing the UV rays (see FIGS. 23 and 24 thereof).

However, none of the solutions mentioned above fully protects LGPs from discoloration induced by UV rays. This is because the discoloration is induced by UV rays not only coming from lamp radiation, but also coming from other radiation sources. An LGP includes many surfaces in addition to the light incidence surface, and UV rays from other radiative sources may impinge on these surfaces and thus eventually degrade the performance of the LGP. In a transmission type LCD, for example, UV rays from sunlight may pass through the liquid crystal panel in a reverse direction, impinging on the light emitting surface of the LGP. In a reflection type LCD, where the LGP is generally located in front of the liquid crystal panel to guide the ambient light into the liquid crystal panel, the LGP is even more susceptible to discoloration from UV rays. Furthermore, an LGP may be exposed to ambient UV rays before assembly into an LCD.

The fifth solution described above of adding an isolating material into the material of the LGP is not an efficient means for preventing discoloration of the LGP. This is because it would require a large quantity of isolating material to added into the LGP to effectively absorb the UV rays coming from the lamp or from outside. This would unduly increase the cost of the backlight assembly.

### SUMMARY OF THE INVENTION

An object of the present invention is to provide a low cost light guide plate which resists discoloration due to UV rays.

In one embodiment of the present invention, a backlight system comprises a light source, a light guide plate, and a masking film. The light guide plate comprises a light incidence surface positioned adjacent to the light source for receiving light emitted by the light source, and a light emitting surface that orthogonally joins the light incidence surface. The masking film is provided on the light emitting surface to block UV rays from penetrating therethrough.

The masking film prevents the light guide plate from discoloring due to external UV rays. Good performance of the light guide plate is thus maintained at low cost.

Other objects, advantages, and novel features of the present invention will become more apparent from the following detailed description when taken in conjunction with the accompanying drawings.

### BRIEF DESCRIPTION OF THE DRAWINGS

FIG. 1 is a schematic sectional view of operation of a light guide assembly according to a first embodiment of the present invention;

FIG. 2 is a top plan view of the light guide assembly of FIG. 1;

FIG. 3 is a schematic side view of operation of a backlight system according to the present invention, the backlight system comprising the light guide assembly of FIG. 1;

FIG. 4 is a schematic side view of operation of a transmission type LCD assembly according to the present invention, the transmission type LCD assembly comprising the backlight system of FIG. 3;

FIG. 5 is a schematic side view of operation of a light guide assembly according to a second embodiment of the present invention;

FIG. 6 is a schematic side view of operation of a front light system according to the present invention, the front light system comprising the light guide assembly of FIG. 5; and

FIG. 7 is a schematic side view of operation of a reflection type LCD assembly according to the present invention, the reflection type LCD assembly comprising the front light system of FIG. 6.

### DESCRIPTION OF THE PREFERRED EMBODIMENTS

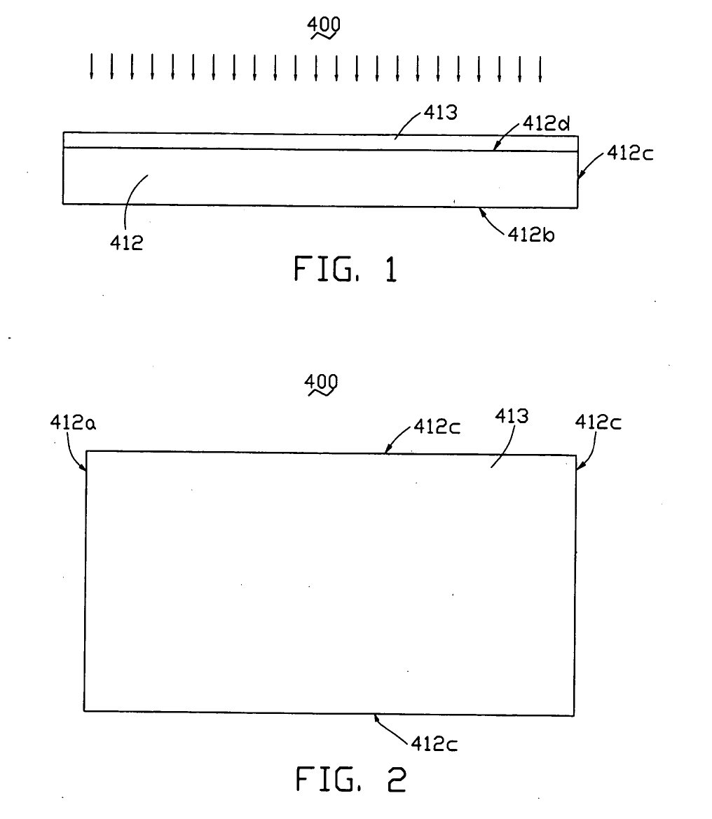

Referring to FIGS. 1 and 2, a light guide assembly 400 in accordance with a first embodiment of the present invention includes a plate-like LGP (light guide plate) 412 and a masking film 413. The LGP 412 includes a light emitting surface 412d, a bottom surface 412b opposite to the light emitting surface 412d, and a plurality of side surfaces 412c joining the two surfaces 412b and 412d. At least one of the side surfaces 412c of the LGP 412 is a light incidence surface 412a receiving light emitted by a lamp (not shown), and the other side surfaces 412c are light reflection surfaces.

The masking film 413 is provided on the light emitting surface 412d for blocking external UV rays. The masking film 413 may be made of a suitable material, such as a transitional metal oxide or SiO₂, which has the ability to block UV rays. The masking film 413 may be formed on the light emitting surface 412d by printing or by laser deposition. Alternatively, the masking film 413 may be attached to the light emitting surface 412d. A thickness of the masking film 413 is from 0.3 micrometers to several micrometers.

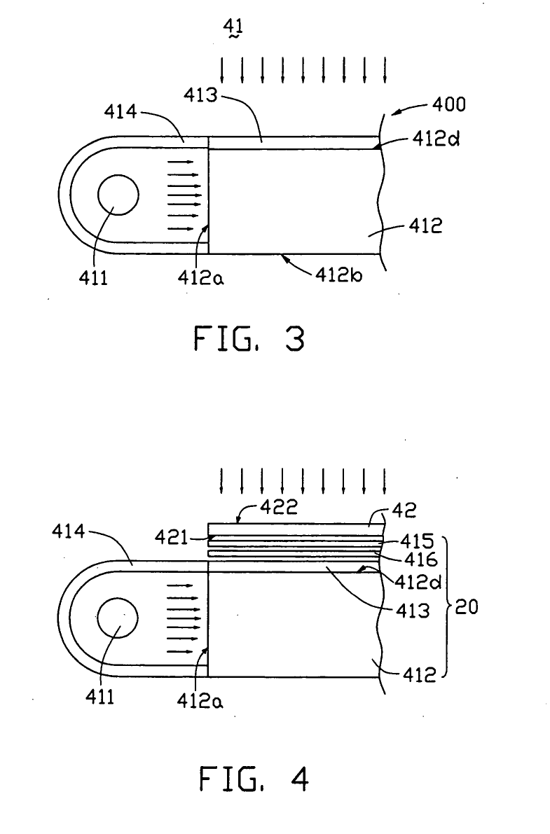

Referring to FIG. 3, a backlight system 41 comprises a light source 411 secured in a lamp cover 414 for emitting light, and the LGP 412 and the masking film 413 of light guide assembly 400. The light incidence surface 412a of the LGP 412 is adjacent to the light source 411 and receives light emitted by the light source 411. The masking film 413 provided on the light emitting surface 412d blocks external UV rays.

In practice of the backlight system 41, a plurality of optical sheets (not shown), such as diffusing sheets or prism sheets, may be placed on the light emitting surface 412d to make the illumination provided by the backlight system 41 more bright and uniform. The masking film 413 may be attached to the light emitting surface 412d, or to a surface of any of the optical sheets. The optical sheets can also include added isolating material, in order to block UV rays from penetrating therethrough. In the same way, the masking film 413 can protect the LGP 412 from discoloration due to external UV rays.

Referring to FIG. 4, a transmission type LCD assembly in accordance with the present invention comprises a liquid crystal panel 42 and an illumination system 20. The liquid crystal panel 42 comprises a bottom surface 421, and an opposite top display surface 422. The illumination system 20 is essentially the same as the backlight system 41. The illumination system 20 includes a plurality of optical sheets, such as a diffusing sheet 416 together with a prism sheet 415, successively arranged on the light emitting surface 412d. The liquid crystal panel 42 is arranged on the prism sheet 415, with the bottom surface 421 opposing the prism sheet 415. The light emitting surface 412d of the light guide plate 412 is optically matched with the bottom surface 421 of the liquid crystal panel 42.

In operation of the transmission type LCD assembly, the light emitted by the lamp 411 enters the LGP 412 through the light incidence surface 412a, and is guided by the LGP 412 to emit from the light emitting surface 412d. Then, the light passes through the diffusing sheet 416 and the prism sheet 415 and enters the liquid crystal panel 42 via the bottom surface 421. The liquid crystal panel 42 acts as a shutter to transmit or block the light emitted by the illumination system 20. In the same way, external UV rays may pass through the liquid crystal panel 42 in a reverse direction, but are then blocked by the masking film 413. Thus, it is possible to prevent yellow discoloration of the LGP 412 by UV rays. The transmission type LCD assembly incorporating the masking film 413 can attain good performance with low cost when compared with corresponding prior art assemblies.

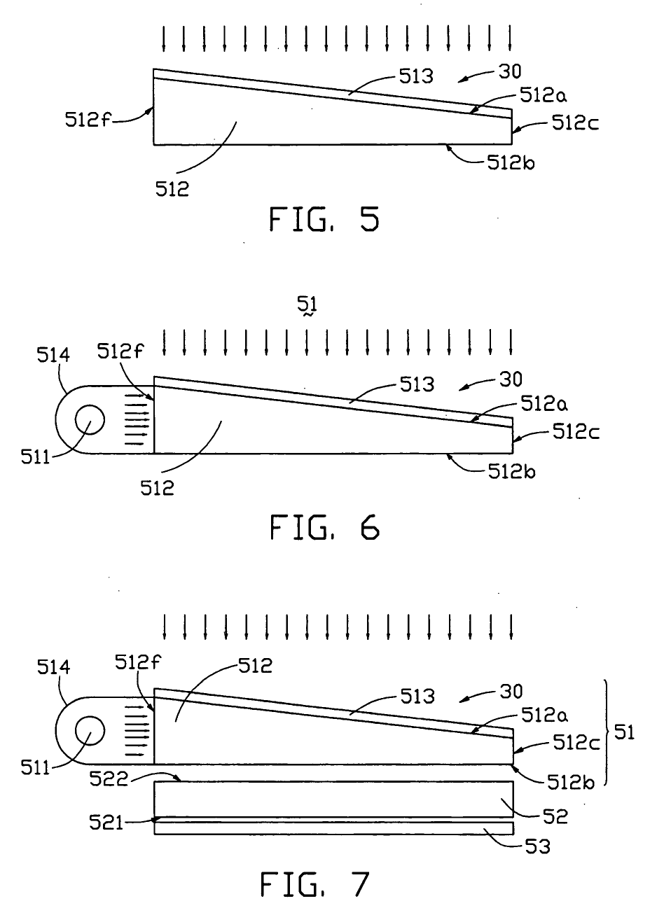

Referring to FIG. 5, a light guide assembly 30 used in a reflection type LCD in accordance with a second embodiment of the present invention is wedge-shaped. The light guide assembly 30 comprises an LGP 512 and a masking film 513. The LGP 30 includes a light incidence surface 512a for receiving external light, a light transmitting surface 512b opposite to the light incidence surface 512a for transmitting light, a plurality of side surfaces 512f, 512c, and a masking film 513. The masking film 513 is provided on the light incidence surface 512a to block external UV rays. The masking film 513 may, for example, be attached to the light incidence surface 512a.

Referring to FIG. 6, a front light system 51 in accordance with the present invention comprises the light guide assembly 30 having the masking film 513. The masking film 513 provided on the light emitting surface 512a blocks external UV rays. In addition, a light source 511 secured in a lamp cover 514 is disposed adjacent to the side surface 512f of the LGP 512, to provide light to the LGP 40.

Referring to FIG. 7, a reflection type LCD assembly in accordance with the present invention comprises a liquid crystal panel 52, and the front light system 51 for guiding external light. The liquid crystal panel 52 is disposed under the front light system 51, and comprises a bottom surface 521 and an opposite top display surface 522. The light transmitting surface 512b of the LGP 512 opposes the display surface 522 of the liquid crystal panel 52, and is optically matched with the display surface 522. The masking film 513 formed on the light incidence surface 512a of the LGP 512 blocks external UV rays.

In operation of the reflection type LCD assembly, external light or a combination of the external light and the light emitted from the light source 511 is utilized. Light emitted from the light source 511 is guided by the LGP 512 and passes through the light transmitting surface 512b. Then the light enters the liquid crystal panel 52. Further, light from the external environment of the reflection type LCD assembly passes through the LGP 512 and enters the liquid crystal panel 52. These two sources of light are reflected by a reflection sheet 53 that is located under the liquid crystal panel 52, and re-enter the liquid crystal panel 52. At the same time, UV rays from the external environment are blocked by the masking film 513 formed on the light emitting surface 512d of the LGP 512. Discoloration of the LGP 512 induced by external UV light can be eliminated, thus preserving the display performance of the reflection type LCD assembly.

In the above-described embodiments, the masking film 413, 513 is easily formed. In addition, a quantity of material used for the masking film 413 is less than that of comparable prior art assemblies. That is, unlike prior art assemblies, in the present invention there is no need for material to be added to the material that makes up the LGP. Thus, a light guide assembly, a backlight system, a front light system and a liquid crystal display using the masking film 413, 513 can achieve good performance over a long period.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. A light guide assembly comprising:
a light guide plate having:
a light incidence surface; and
a light emitting surface which orthogonally joins the light incidence surface;
and
a masking film;
wherein the masking film is provided on the light emitting surface for blocking UV rays from penetrating therethrough.

2. The light guide assembly as claimed in claim 1, wherein the masking film is formed by printing.

3. The light guide assembly as claimed in claim 1, wherein the masking film is formed by laser deposition.

4. The light guide assembly as claimed in claim 1, wherein the masking film is attached to the light emitting surface of the light guide plate.

5. A light guide assembly comprising:
a light guide plate having:
a light incidence surface for receiving external light; and
a light transmitting surface opposite to the light incidence surface for transmitting light; and
a masking film;
wherein the masking film is located on at least one of the light incidence surface and the light transmitting surface for blocking UV rays from penetrating therethrough.

6. The light guide assembly as claimed in claim 5, wherein said masking film is applied upon the light incidence surface.

7. A light system for emitting light beams, comprising:
a light source for emitting light;
a light guide plate having:
a light incidence surface adjacent to the light source for receiving light emitted by the light source; and
a light emitting surface angled with regard to the light incidence surface; and
a masking film;
wherein the masking film is provided on the light emitting surface for blocking UV rays from penetrating therethrough.

8. The light system as claimed in claim 7, wherein the masking film is attached to the light emitting surface.

9. The light system as claimed in claim 7, further comprising at least an optical sheet on the light emitting surface, wherein the masking film is attached to said optical sheet.

10. The light system as claimed in claim 9, wherein said optical sheet is a diffusing sheet.

11. The light system as claimed in claim 9, wherein said optical sheet is a prism sheet.

12. The light system as claimed in claim 7, comprising at least one optical sheet on the light emitting surface, wherein said optical sheet includes added isolating material for blocking UV rays from penetrating therethrough.

13. The light system as claimed in claim 7, wherein said light emitting surface orthogonally joins the light incidence surface.
